(19) United States
(12) Patent Application Publication
(10) Pub. No.: US 2007/0279544 A1
(43) Pub. Date: Dec. 6, 2007

(54) Wiring for display device and thin film transistor array panel including the same and method for manufacturing thereof

(75) Inventors: Yang-Ho Bae, Suwon-si (KR); Soon-Kwon Lim, Yongin-si (KR); Chang-Oh Jeong, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/445,047

(22) Filed: May 31, 2006

(30) Foreign Application Priority Data
May 31, 2006 (KR) 10-2005-0046147

(51) Int. Cl. G02F 1/136

(52) U.S. Cl. 349/43

(57) ABSTRACT

The present invention provides a manufacturing method of a thin film transistor array panel comprising forming a gate line on a substrate, forming a gate insulating layer and a semiconductor layer on the gate line in sequence, forming a data line having a source electrode and a drain electrode on the gate insulating layer and the semiconductor layer, and forming a pixel electrode connected to the drain electrode. At least one of the formation of the gate line and the formation of the data line includes a step of forming a slurry layer which is a mixture of conductor particles and a solvent, patterning the slurry layer by using a shaping mold with a prescribed pattern, and removing the shaping mold.

### REFERENCE TO RELATED APPLICATION

This application claims priority to Korean Patent Application No. 2005-0046147, filed on May 31, 2005, and all the benefits accruing therefrom under 35 U.S.C. §119, and the contents of which in its entirety are herein incorporated by reference.

### BACKGROUND OF THE INVENTION

1. Field of the Invention

The present invention relates to wiring for a display device, a thin film transistor (TFT) array panel including the same, and a manufacturing method thereof.

2. Description of the Related Art

Liquid crystal displays (LCDs) are one of the most widely used flat panel displays. An LCD includes a liquid crystal (LC) layer interposed between two panels provided with field-generating electrodes. The LCD displays images by applying voltages to the field-generating electrodes to generate an electric field in the LC layer that determines the orientations of the LC molecules and their polarization of incident light. A conventional LCD has a plurality of pixel electrodes arranged in a matrix on one of the panels and a common electrode covering the entire surface of the other panel. The LCD displays images by applying a different voltage to each pixel electrode. For this purpose, thin film transistors (TFTs) having three terminals to switch voltages applied to the pixel electrodes are connected to the pixel electrodes. Gate lines transmit signals for controlling the thin film transistors and data lines transmit voltages to the pixel electrodes. The thin film transistors (TFTs) may be formed on a thin film transistor array panel. A TFT transmits image signals from the data line to the pixel electrode in response to scanning signals from the gate line. The TFT may be configured as a switching element to drive an active matrix organic light emitting display (AM-OLED) for controlling its respective light emitting elements.

Because a TFT array panel includes multiple layers each having different shapes, separate masks are required to form each layer of the TFT array panel. Each time a mask is employed the process includes such steps as washing, coating a photoresist, pre-baking, exposing, developing, post-baking, etching, and stripping a photosensitive film. This results in a remarkable increase in manufacturing costs. It has been suggested that the number of processing steps could be reduced by using slits, but this suggestion encounters the difficulty of setting up the processing conditions and the measurement of wiring is not uniform.

### SUMMARY OF THE INVENTION

The present invention solves the above mentioned problems and substantially reduces manufacturing costs and time by forming uniform wiring without using masks. In accordance with an aspect of the invention, the wiring for an display device is formed by sintering conductor particles with sizes smaller than 200 nm. More particularly, the inventive process comprises forming at least one of the gate lines and the data lines by sintering such conductor particles from a slurry layer mixture of such conductor particles and a solvent on an insulating substrate, patterning the slurry layer by using a shaping mold having a prescribed pattern, and removing the shaping mold.

The present invention further provides a thin film transistor array panel comprising a substrate, a gate line and a data line formed on the substrate and intersecting each other, a thin film transistor connected to the gate line and the data line, and a pixel electrode connected to the thin film transistor. At least one of the gate line and the data line is formed by sintering conductor particles whose sizes are smaller than 200 nm.

The present invention further provides a manufacturing method of a thin film transistor array panel, comprising forming a gate line on a substrate, forming a gate insulating layer on the gate line and a semiconductor layer the gate insulating layer, forming a data line having a source electrode and a drain electrode disposed opposite the source electrode with respect to the gate electrode therebetween on the gate insulating layer and the semiconductor layer, and forming a pixel electrode connected to the drain electrode. At least one of the formation of the gate line and the formation of the data line comprises a step of forming a slurry layer which is a mixture of conductor particles and a solvent, patterning the slurry layer by using a shaping mold with a prescribed pattern, and removing the shaping mold.

### BRIEF DESCRIPTION OF THE DRAWINGS

FIG. 1 is a layout view of a TFT array panel according to an embodiment of the present invention;

FIGS. 2 and 3 are sectional views of the TFT array panel shown in FIG. 1 taken along the line II-II and the line III-III;

FIGS. 4 to 9 are sectional views sequentially illustrating the intermediate steps of a method of manufacturing a TFT array panel according to an embodiment of the present invention;

FIGS. 10, 13, 16, and 19 are layout views sequentially illustrating the intermediate steps of a method of manufacturing a TFT array panel according to an embodiment of the present invention;

FIGS. 11 and 12 are sectional views of the TFT array panel shown in FIG. 10 taken along the line XI-XI and the line XII-XII;

FIGS. 14 and 15 are sectional views of the TFT array panel shown in FIG. 13 taken along the line XIV-XIV and the line XV-XV;

FIGS. 17 and 18 are sectional views of the TFT array panel shown in FIG. 16 taken along the line XVII-XVII and the line XVIII-XVIII; and

FIGS. 20 and 21 are sectional views of the TFT array panel shown in FIG. 19 taken along the line XX-XX and the line XXI-XXI.

### DETAILED DESCRIPTION OF THE PREFERRED EMBODIMENTS

Preferred embodiments of the present invention will now be described more fully hereinafter with reference to the accompanying drawings, in which preferred embodiments of the invention are shown. The present invention may, however, be embodied in different forms and should not be construed as being limited to the embodiments set forth herein. Rather, these embodiments are provided so that this disclosure will be thorough and complete, and will fully convey the scope of the invention to those skilled in the art. In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

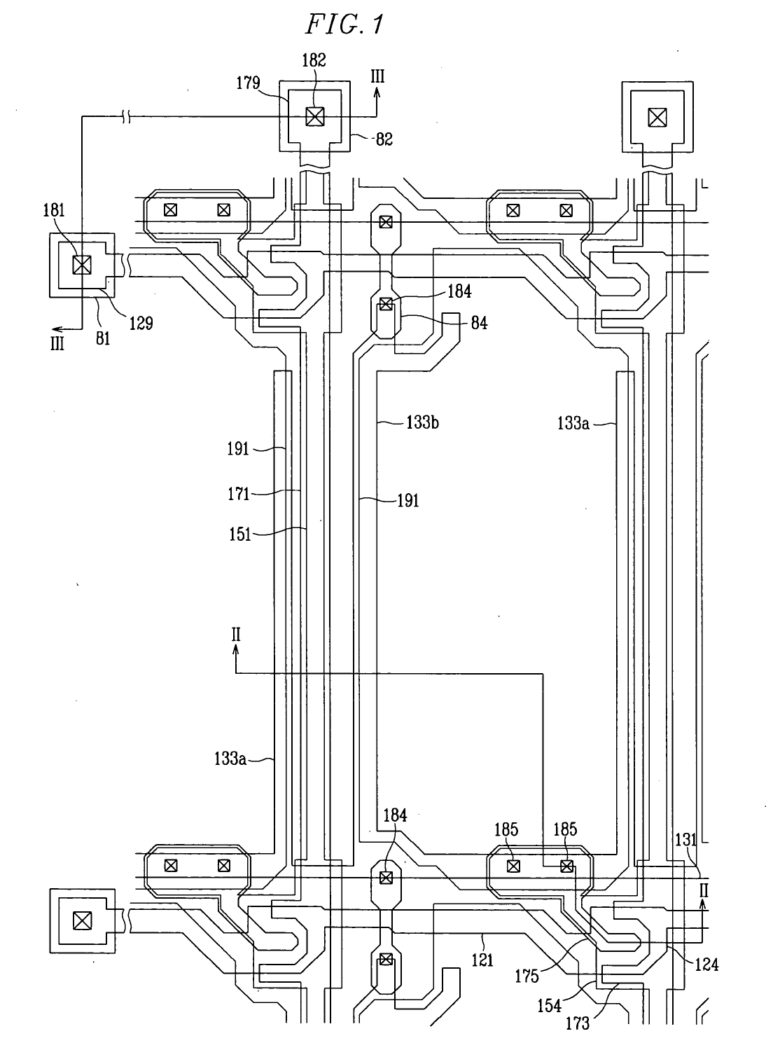

Referring to FIG. 1, a layout view of a TFT array panel according to an embodiment of the present invention is shown. A plurality of gate lines 121 and a plurality of storage electrode lines 131 are formed on an insulating substrate 110 made of a material such as transparent glass or plastic. The gate lines 121 for transmitting gate signals extend substantially in a transverse direction. Each of the gate lines 121 includes a plurality of gate electrodes 124 that protrude downward and an end portion 129 having a large area for connection with another layer or an external gate driver. The gate driver (not shown) for generating the gate signals may be mounted on a flexible printed circuit film (not shown) attached to the substrate 110, directly fabricated on the substrate 110, or integrated into the substrate 110. When the gate driver is integrated into the substrate 110, the gate lines 121 may be extended to be directly connected to it.

The storage electrode line 131 for receiving a prescribed voltage includes a stem line running nearly parallel with the gate line 121 and a plurality of pairs of storage electrodes 133a and 133b. Each of the storage electrode lines 131 is located between two adjacent gate lines 121, and the stem line is near the lower one of the two gate lines 121. Each of the storage electrodes 133a and 133b includes a fixed terminal connected to the stem line and a free terminal on the opposite side. The fixed terminal of the storage electrode 133b has a large area, and the free terminal of the storage electrode 133b is divided into a straight portion and a crooked portion. However, the shape and disposition of the storage electrode line 131 may be variously changed.

The gate line 121 and the storage electrode line 131 may be made of an Al-containing metal such as Al or an Al-alloy, an Ag-containing metal such as Ag or a Ag-alloy, a Cu-containing metal such as Cu or a Cu-alloy, a Mo-containing metal such as Mo or a Mo-alloy, Cr, Ni, Ta, Ti, and so forth. However, the gate line 121 and the storage electrode line 131 may have a structure of multiple layers including two conductive layers (not shown) having different physical properties. One of the two conductive layers is made of a metal with low resistivity, such as an Al-containing metal, a Ag-containing metal, and a Cu-containing metal in order to reduce a voltage drop. The other conductive layer is made of a different material, particularly one having great physical, chemical, and electrical adhesiveness to indium tin oxide (ITO) and indium zinc oxide (IZO), such as a Mo-containing metal, Cr, Ti, and Ta. Examples of this combination include a lower layer of Cr with an upper layer of Al (alloy) and a lower layer of Al (alloy) with an upper layer of Mo (alloy). Alternatively, the gate line 121 and the storage electrode line 131 may be made of many various metals or conductors besides the above.

The lateral sides of the gate lines 121 and the storage electrode lines 131 are inclined relative to a surface of the substrate 110, and the preferable inclination angle thereof ranges from about 30 to 80 degrees. A gate insulating layer 140 made of a material such as silicon nitride (SiNx) or silicon oxide (SiOx) is formed on the gate lines 121, the storage electrode lines 131 and the substrate 110. A plurality of semiconductor stripes 151 made of such materials as hydrogenated amorphous silicon (abbreviated to “a-Si”) or polysilicon are formed on the gate insulating layer 140. Each semiconductor stripe 151 extends substantially in the longitudinal direction and has a plurality of projections 154 branched out toward the gate electrodes 124. The width of each semiconductor stripe 151 becomes large near the gate lines 121 and the storage electrode lines 131 to cover large areas of the gate lines 121 and the storage electrode lines 131.

A plurality of ohmic contact stripes 161 and islands 165 are formed on the semiconductor stripes 151. The ohmic contacts 161 and 165 may be made of a material such as n+ hydrogenated a-Si heavily doped with an n-type impurity such as phosphorus (P) or silicide. Each ohmic contact stripe 161 has a plurality of projections 163, and the projections 163 and the ohmic contact islands 165 are located in pairs on the projections 154 of the semiconductor stripes 151.

The lateral sides of the semiconductor stripes 151 and the ohmic contacts 161 and 165 are also inclined relative to a surface of the substrate 110, and the inclination angle thereof ranges from about 30 to 80 degrees. A plurality of data lines 171 and a plurality of drain electrodes 175 are formed on the ohmic contacts 161 and 165 and the gate insulating layer 140. The data lines 171 for transmitting data voltages extend substantially in the longitudinal direction and intersect the gate lines 121. Each data line 171 also intersects the storage electrode lines 131 and is located between the adjacent storage electrodes 133a and 133b. Each data line 171 includes a plurality of source electrodes 173 branched out toward the gate electrodes 124 and an end portion 179 having a large area for connection with another layer or an external driving circuit. The data driver (not shown) for generating the data signals may be mounted on a flexible printed circuit film (not shown) attached to the substrate 110, directly fabricated on the substrate 110, or integrated into the substrate 110. When the data driver is integrated into the substrate 110, the data lines 121 may be extended to be directly connected to it.

Each drain electrode 175 is separated from the data line 171 and opposes the source electrode 173 with respect to a gate electrode 124. Each drain electrode 175 has an end portion having a large area and the other stick-shaped end portion. The end portion having a large area overlaps the storage electrode line 131, and the stick-shaped end portion is partially surrounded by the source electrode 173 curved in the shape of a U. A gate electrode 124, a source electrode 173, and a drain electrode 175, along with a projection 154 of a semiconductor stripe 151, form a TFT having a channel formed in the projection 154 disposed between the source electrode 173 and the drain electrode 175. The data line 171 and the drain electrode 175 are preferably made of a metal such as Ag, Cu, Mo, Cr, Ni, Co, Ta, and Ti, or an alloy thereof. Also, the data line 171 and the drain electrode 175 may have a structure of multiple layers including a refractory metal layer (not shown) and a conductive layer (not shown) with low resistivity. Examples of the multiple layers are double layers including a lower layer of Cr (alloy) or Mo (alloy) and an upper layer of Al (alloy), and triple layers including a lower layer of Mo (alloy), a middle layer of Al (alloy), and an upper layer of Mo (alloy). However, the data line 171 and the drain electrode 175 may be made of many various metals or conductors besides the above.

The lateral sides of the data lines 171 and the drain electrode 175 are also inclined relative to a surface of the substrate 110, and the inclination angles thereof are preferably in a range of about 30 to 80 degrees. Ohmic contacts 161 and 165 are interposed only between the underlying semiconductor stripes 151 and the overlying data lines 171 and drain electrodes 175 thereon, and reduce the contact resistance therebetween. Most of the semiconductor stripe 151 is narrower than the data line 171, but as mentioned above, the width of the semiconductor stripe 151 broadens near a place where the semiconductor stripe 151 and the gate line 121 meet each other to make the profile of the surface smooth and prevent disconnection of the data line 171. The semiconductor stripe 151 is partially exposed at the place between the source electrode 173 and the drain electrode 175 and at other places not covered with the data line 171 and the drain electrode 175.

A passivation layer 180 is formed on the data line 171, the drain electrode 175, and the exposed portion of the projection 154 of the semiconductor stripe 151. The passivation layer 180 is made of a material such as an inorganic insulator such as silicon nitride or silicon oxide, an organic insulator, or a low dielectric insulator. The organic insulator and the low dielectric insulator have dielectric constants that are preferably lower than 4.0, and examples of the low dielectric insulators are a-Si:C:O and a-Si:O:F formed by plasma enhanced chemical vapor deposition (PECVD). The passivation layer 180 may be made of an organic insulator having photosensitivity, and the surface thereof may be flat. However, the passivation layer 180 may have a double-layered structure including a lower inorganic layer and an upper organic layer so as to protect the exposed portion of the projections 154 of the semiconductor stripes 151 as well as to make use of the substantial insulating property of an organic layer.

The passivation layer 180 has a plurality of contact holes 182 and 185 exposing the end portions 179 of the data lines 171 and portions of the drain electrodes 175, respectively. The passivation layer 180 and the gate insulating layer 140 have a plurality of contact holes 181 exposing the end portions 129 of the gate lines 121 and a plurality of contact holes 184 exposing portions of the storage electrode lines 131 near the fixed terminals of the storage electrodes 133b. A plurality of pixel electrodes 191, a plurality of overpasses 84, and a plurality of contact assistants 81 and 82, which may be made of a transparent conductor such as ITO or IZO, or a reflective metal such as Al, Ag, or an alloy thereof, are formed on the passivation layer 180.

The pixel electrode 191 is physically and electrically connected with the drain electrode 175 through the contact hole 185 and receives the data voltage from the drain electrode 175. The pixel electrode 191 to which the data voltage is applied generates an electric field with a common electrode (not shown) of the opposite panel (not shown) to which a common voltage is applied, so that the direction of the liquid crystal molecules in the liquid crystal layer (not shown) interposed between the two electrodes are determined. The pixel electrode 191 and the common electrode form a capacitor (hereinafter, referred to as a “liquid crystal capacitor”) to store and preserve the received voltage after the TFT is turned off.

The pixel electrode 191 overlaps the storage electrode line 131 including the storage electrodes 133a and 133b. To enhance the voltage storage ability, another capacitor is provided, which is connected with the liquid crystal capacitor in parallel and will be referred to as a “storage capacitor.” The pixel electrode 191 and the drain electrode 175 are electrically connected with the pixel electrode 191 and overlap the storage electrode line 131 to form a capacitor referred to as a storage capacitor, which enhances the voltage storage ability of the liquid crystal capacitor.

The contact assistants 81 and 82 are respectively connected to the end portion 129 of the gate line 121 and the end portion 179 of the data line 171 through the contact holes 181 and 182. The contact assistants 81 and 82 respectively supplement adhesion between the end portion 129 of the gate line 121 and the exterior devices and between the end portion 179 of the data line 171 and the exterior devices, and protect them.

The overpass 84 traverses the gate line 121, and is connected to the exposed portion of the storage electrode line 131 and the exposed end portion of the free terminal of the storage electrode 133b through the contact holes 184 which are disposed opposite each other with the gate line 121 located therebetween. The storage electrode lines 131 including the storage electrodes 133a and 133b, along with the overpasses 84, may be used to repair defects of the gate lines 121, the data lines 171, or the TFTs.

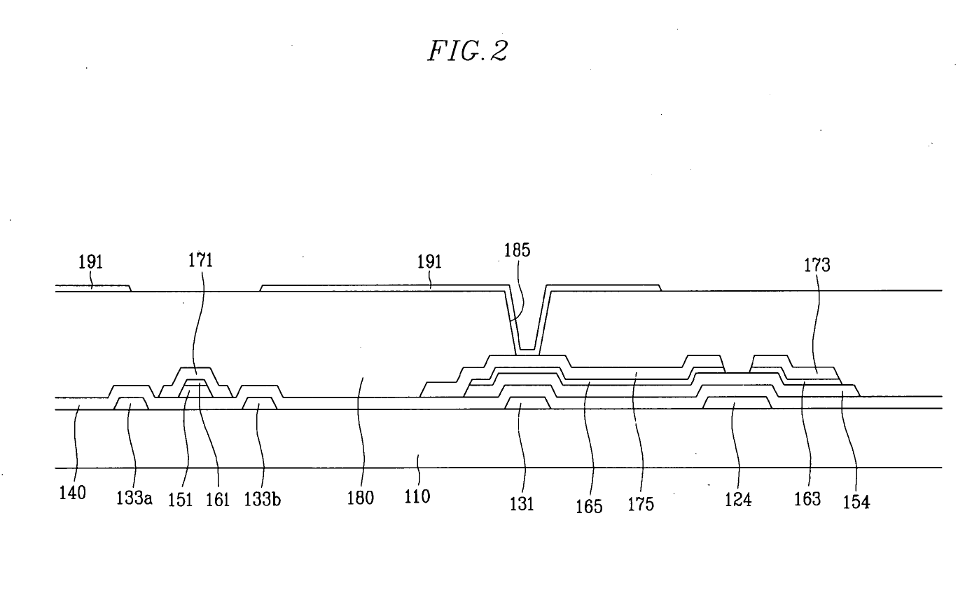

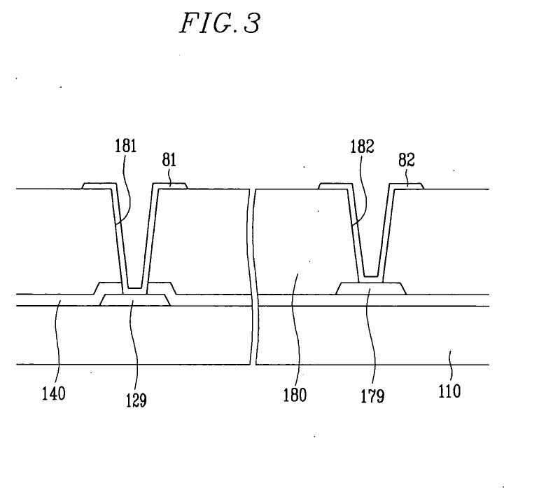

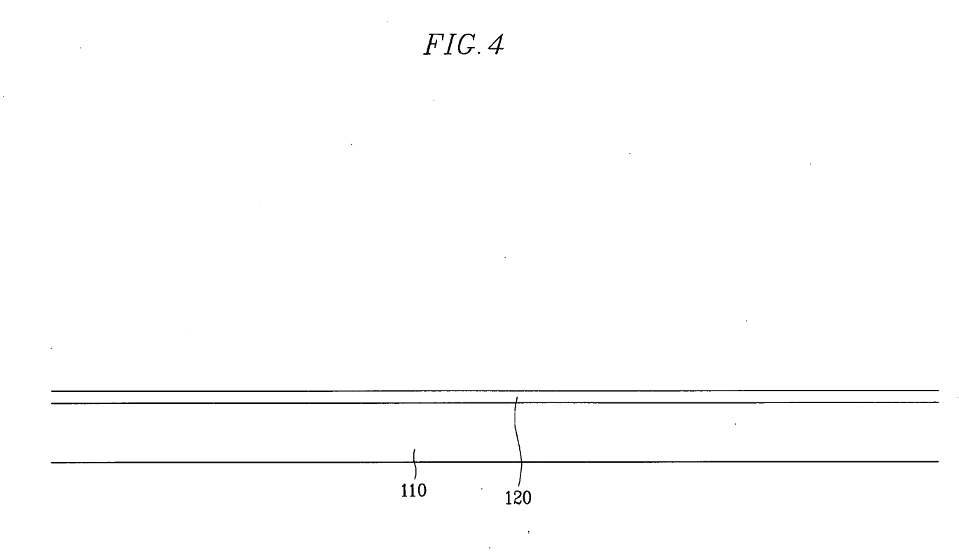

Now, a method of manufacturing the TFT array panel shown in FIGS. 1 to 3 will be described in detail with reference to FIGS. 4 to 21.

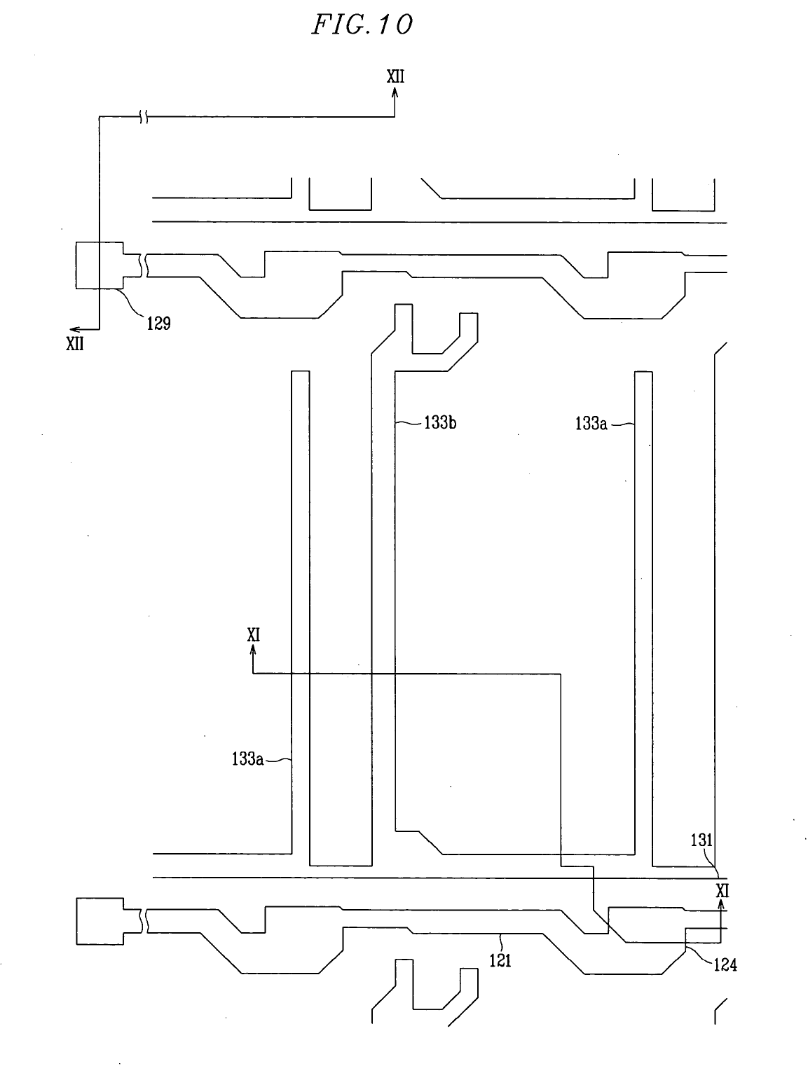

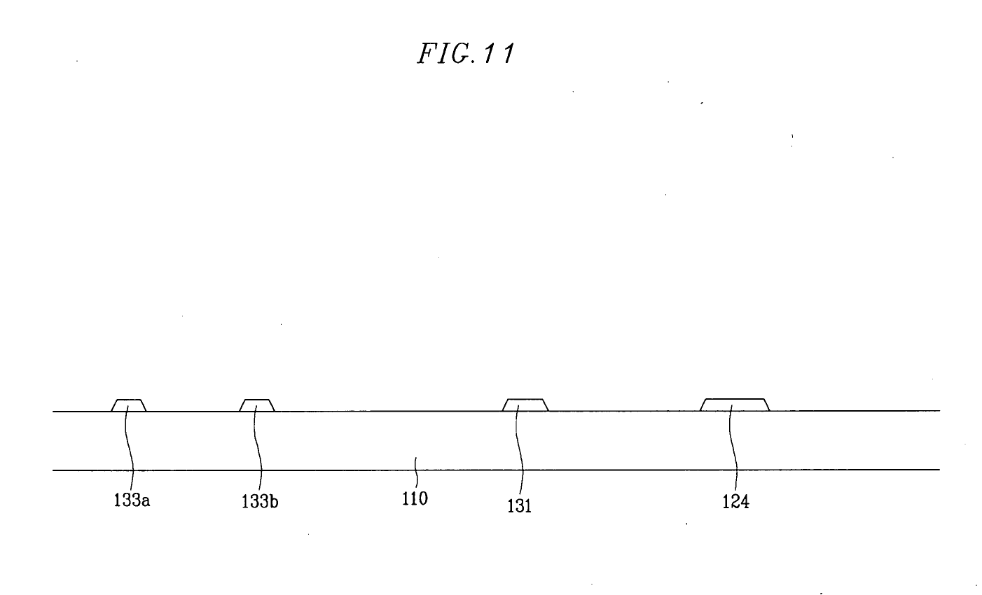

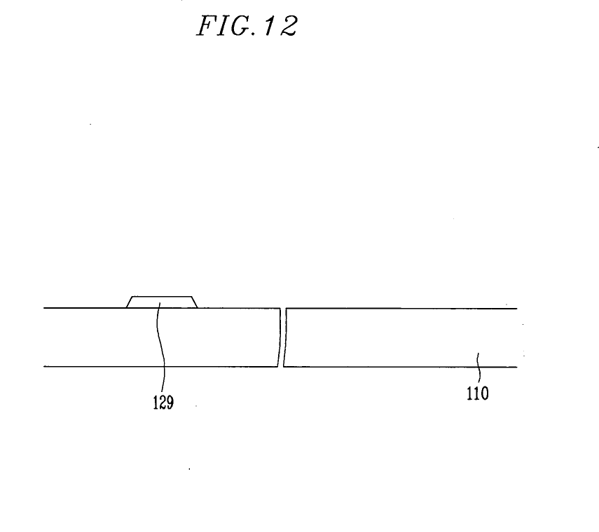

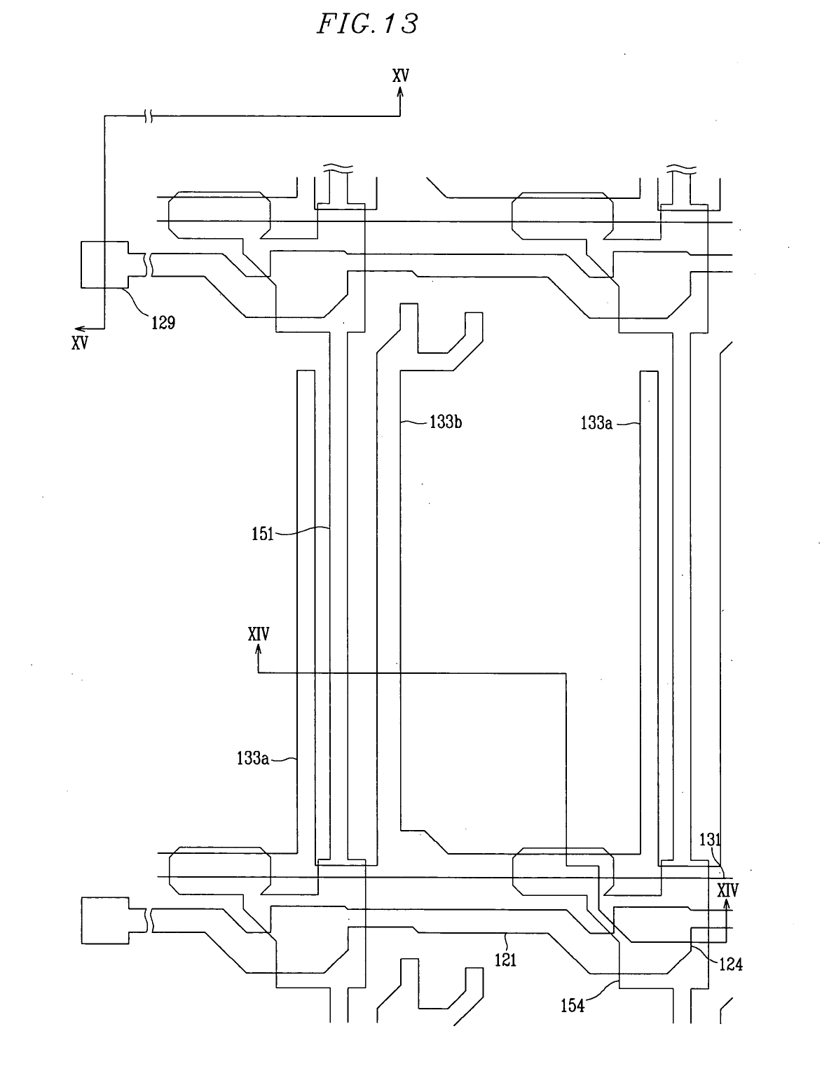

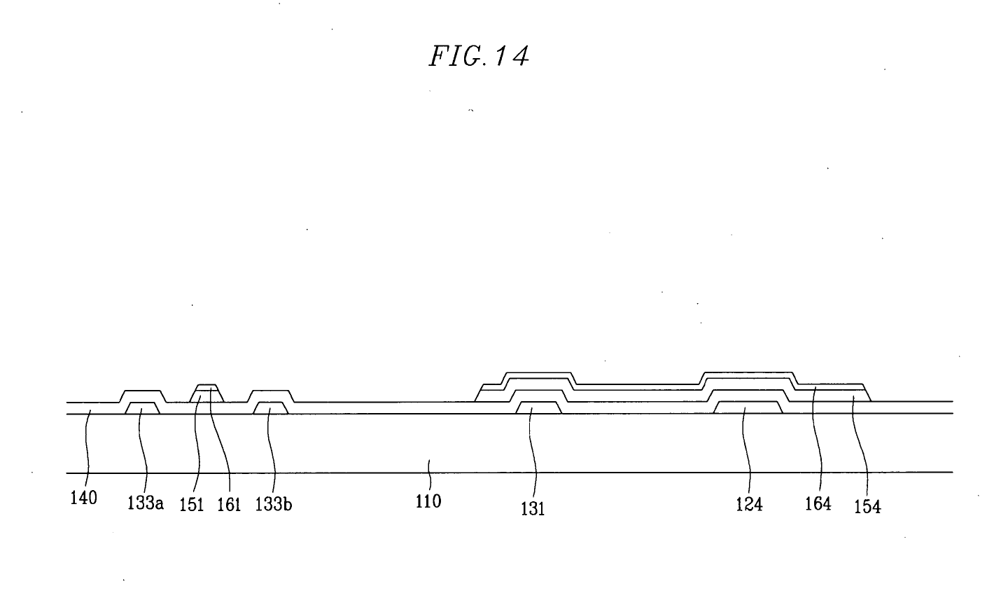

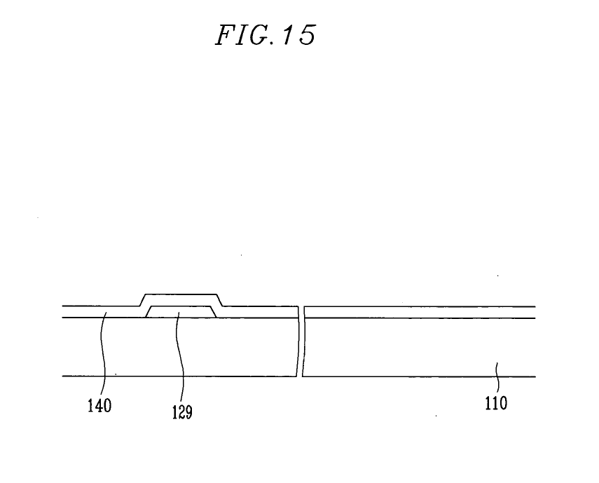

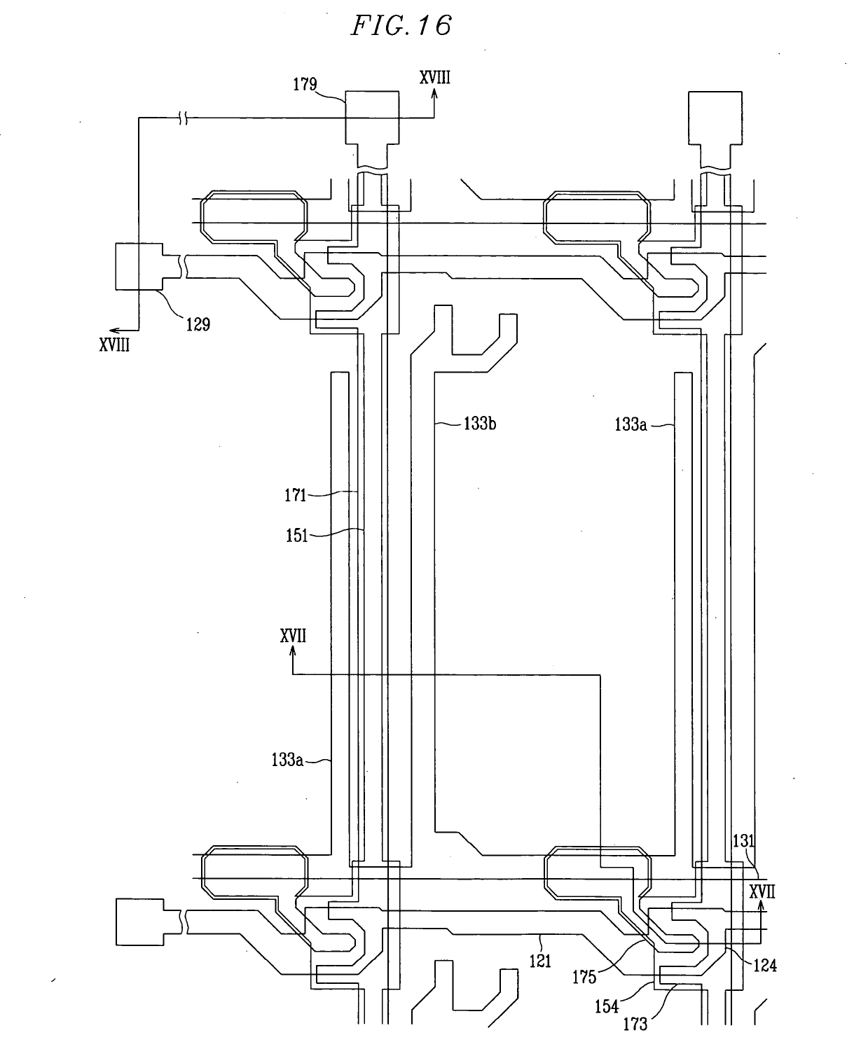

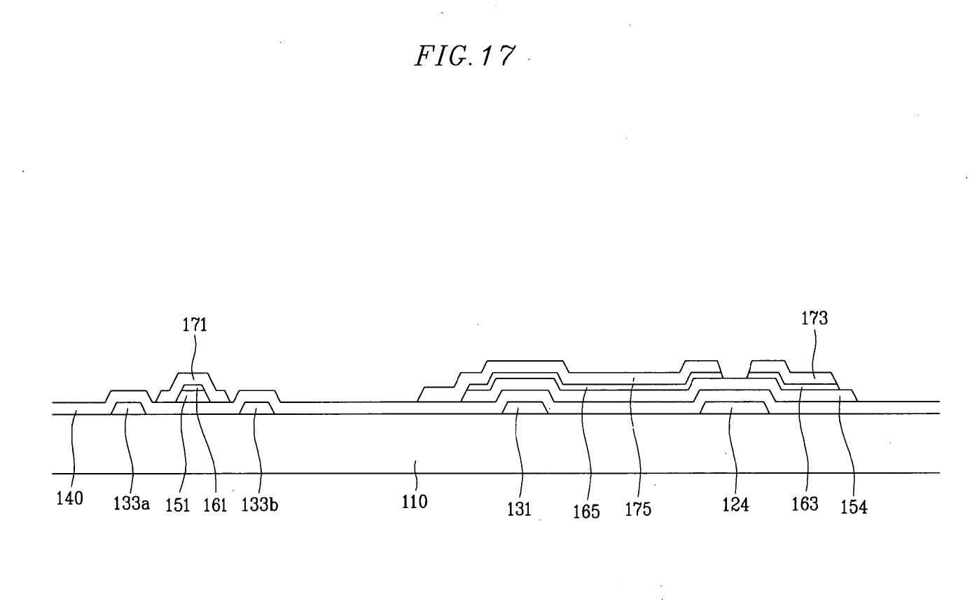

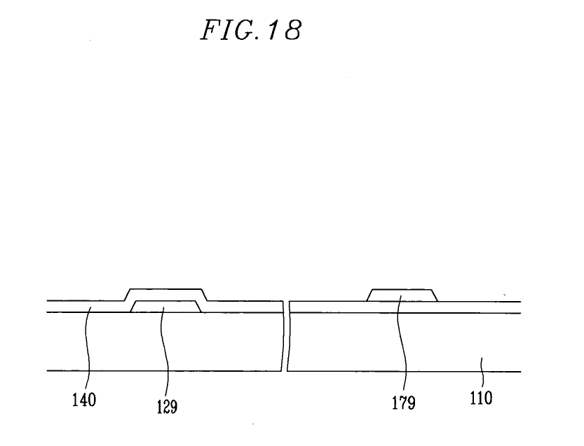

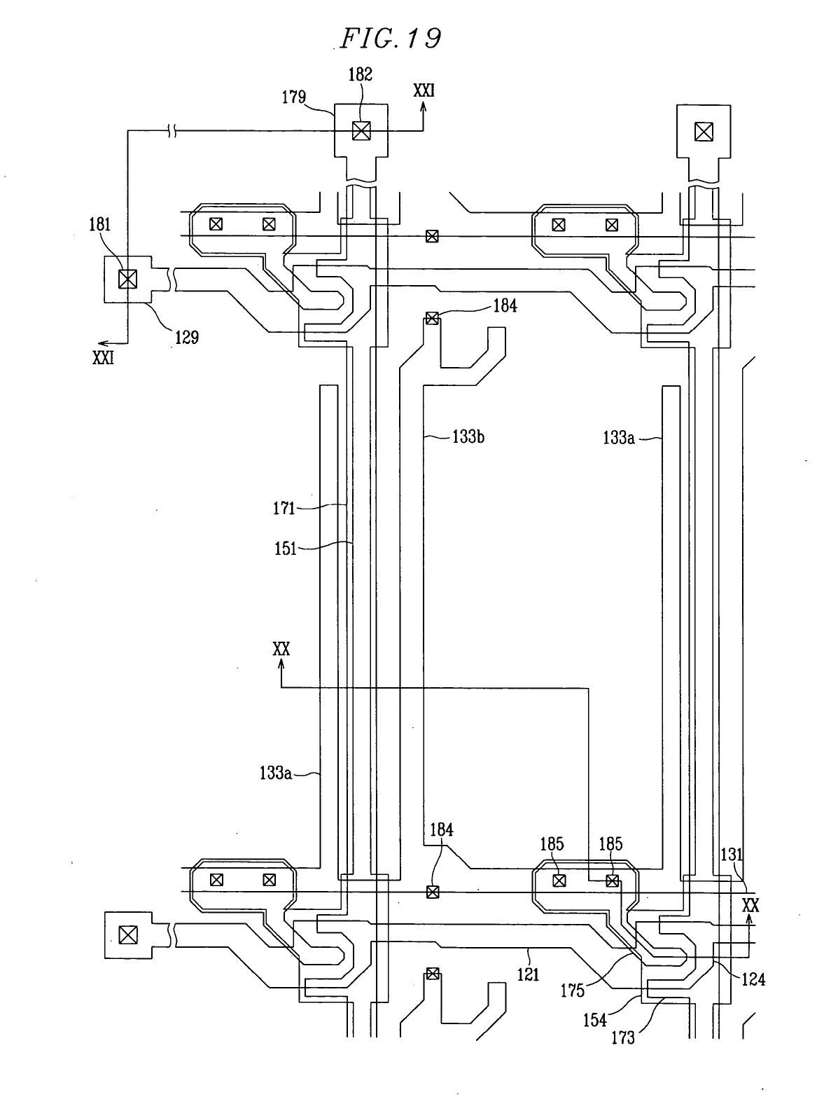

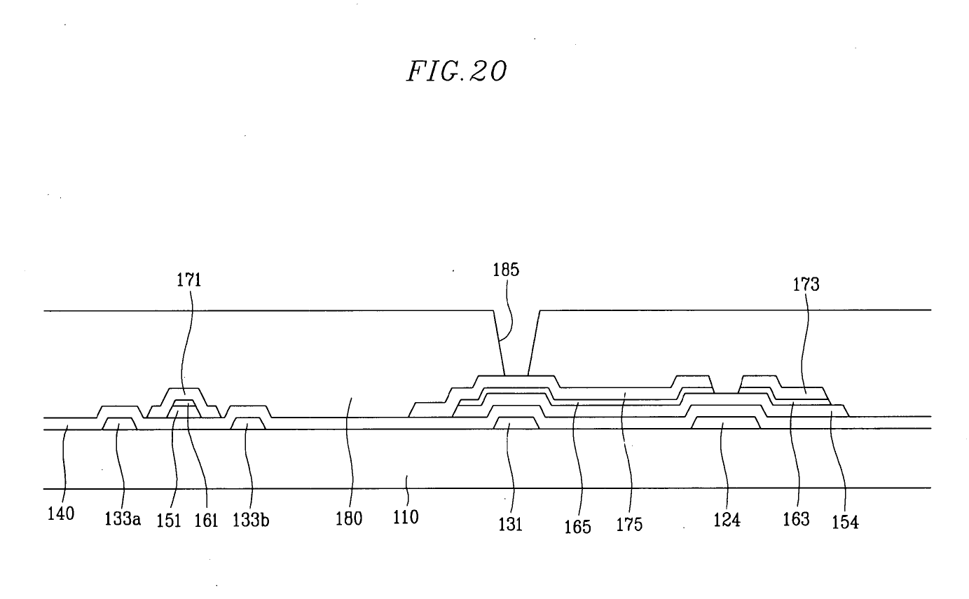

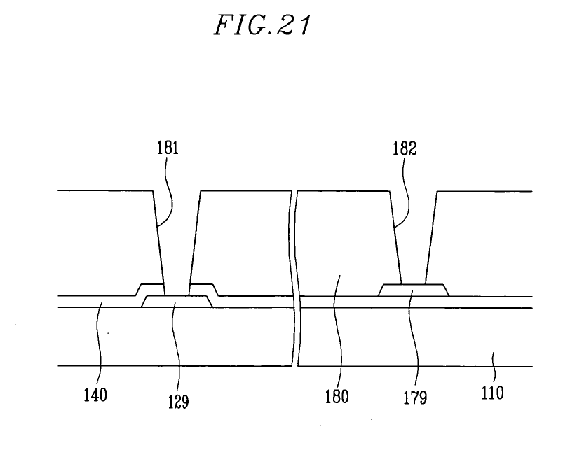

FIGS. 4 to 9 are sectional views sequentially illustrating the intermediate steps of a method of manufacturing a TFT array panel according to an embodiment of the present invention. FIGS. 10, 13, 16, and 19 are layout views sequentially illustrating the intermediate steps of the method of manufacturing a TFT array panel according to an embodiment of the present invention, FIGS. 11 and 12 are sectional views of the TFT array panel shown in FIG. 10 taken along the line XI-XI and the line XII-XII, and FIGS. 14 and 15 are sectional views of the TFT array panel shown in FIG. 13 taken along the line XIV-XIV and the line XV-XV. FIGS. 17 and 18 are sectional views of the TFT array panel shown in FIG. 16 taken along the line XVII-XVII and the line XVIII-XVIII, and FIGS. 20 and 21 are sectional views of the TFT array panel shown in FIG. 19 taken along the line XX-XX and the line XXI-XXI.

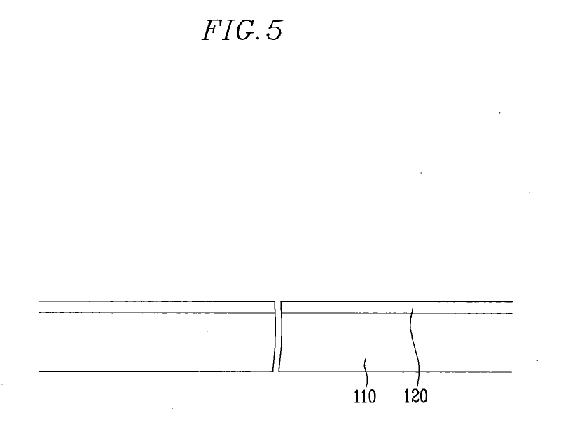

First, as shown in FIGS. 4 and 5, a slurry layer 120 which is a mixture of a metal powder and a solvent is coated on an insulating substrate 110 made of a material such as transparent glass or plastic. The metal powder may be selected from among Al, Cu, Mo, Ag, Cr, Ni, Ti, Ta, and Co, or two or more metal powders may be mixed together or form a multilayer structure. Here, the size of the metal powder particles may be smaller than 200 nm, and preferably range from several nm to several tens of nm. A metal powder whose particle size is larger 200 nm is not applicable to a glass or plastic substrate since the required sintering temperature exceeds 500° C. Hence, when a metal powder of 200 nm maximally, and preferably lower than about 100 nm, is used, it can be sintered at a low temperature that the glass or plastic substrate can withstand, for instance lower than about 400° C. A metal powder including smaller particles such as from several to several tens of nm may be used in order to lower the sintering temperature.

The solvent may be selected arbitrarily from between a polar solvent and a non-polar solvent, and is not limited as long as it can be volatilized at a temperature lower than the sintering temperature. Examples of the solvents are alcohols, benzenes, toluenes, and ethers.

When the metal powder and the solvent are mixed to form a slurry and then coated on the substrate, reactivity of the nano-sized metal powder increases with the size of the surface area, but is controllable. Moreover, uniformity of the wiring is enhanced due to the uniform dispersion of the metal powder. The slurry layer 120 is formed in a layer that is thicker than the finally-formed wiring, which lies in a range from about 0.5 to about 20. Next, the solvent in the slurry layer 120 is partially removed by a heat treatment of the substrate 110 at a low temperature between about 100 and 200° C.

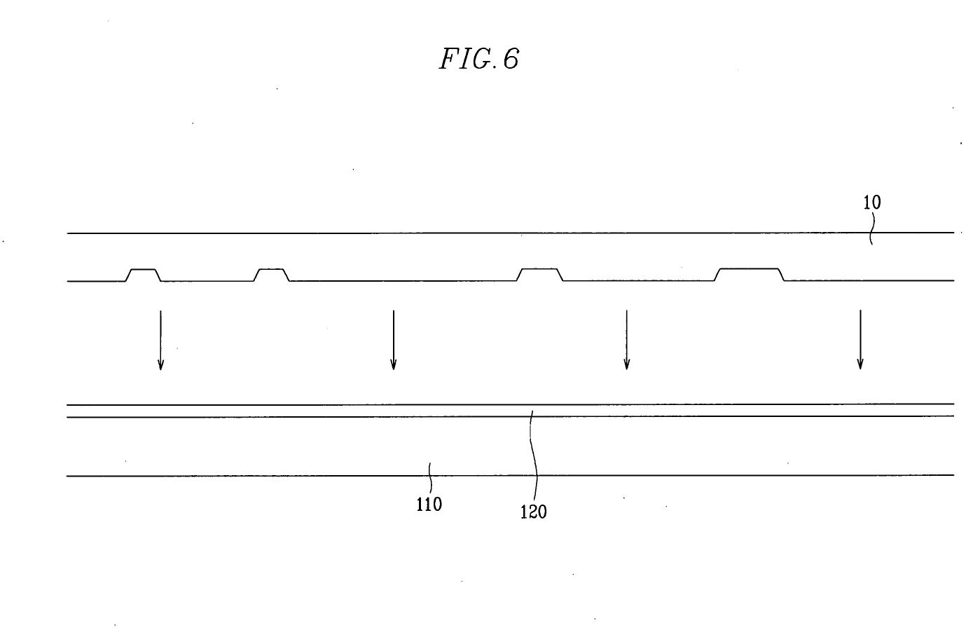

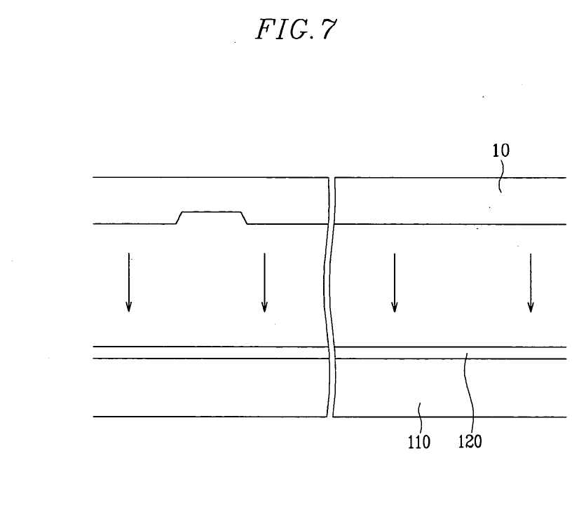

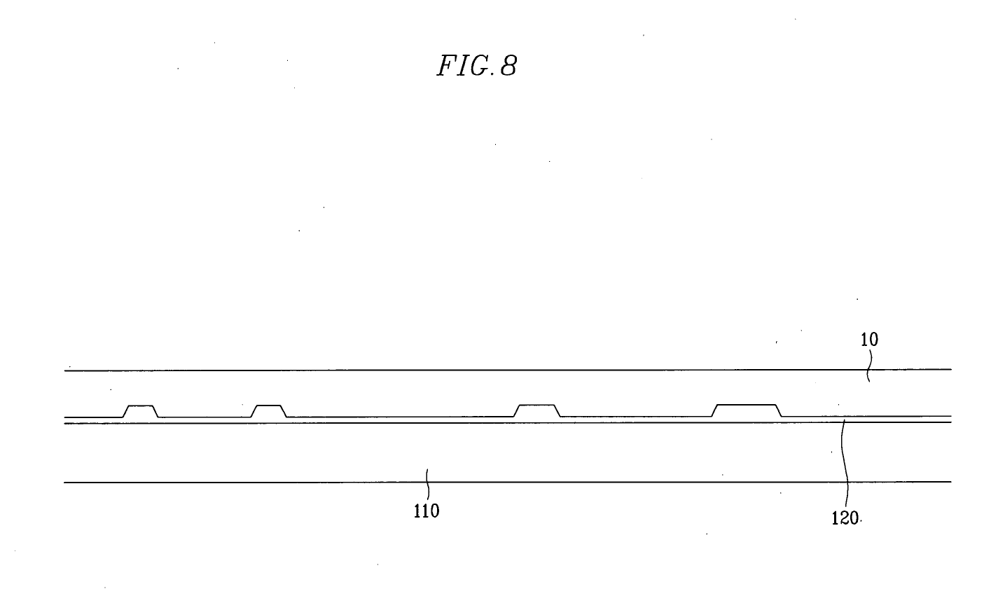

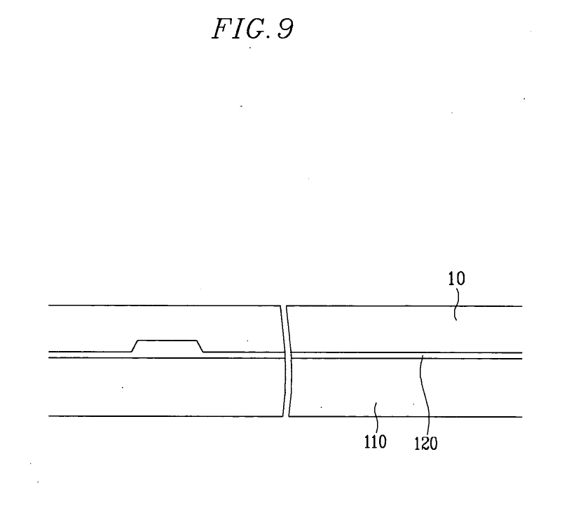

Then, as shown in FIGS. 6 and 7, a shaping mold 10 having a prescribed pattern is disposed on the slurry layer 120. The pattern of the gate line 121 and/or the storage electrode line 131 is engraved in intaglio on the shaping mold. Next, as shown in FIGS. 8 and 9, the slurry layer 120 covered with the shaping mold 10 is pressurized. The fluidity of the slurry layer 120 is sufficient to fill-in the engraved pattern. At the same time as the pressurization, the metal powder is sintered along with removal of the solvent by a heat treatment at a temperature lower than about 500° C., and preferably in a range of about 150 to 500° C. Such sintering proceeds faster with the removal of the solvent and is completed within about 10 minutes.

Then, as shown in FIGS. 10 to 12, gate lines 121 having gate electrodes 124 and end portions 129, and storage electrode lines 131 having storage electrodes 133a and 133b are formed by wet etching or dry etching of the entire surface after the shaping mold is removed.

Next, as shown in FIGS. 13 to 15, after sequential deposition of SiNx, intrinsic a-Si, and a-Si doped with an impurity on the gate line 121, the storage electrode line 131 and the substrate 110, are etched to form: (a) a gate insulating layer 140, (b) semiconductor stripes 151 including a plurality of projections 154 (made of intrinsic a-Si), and (c) ohmic contact stripes 161 including a plurality of ohmic contact patterns 164 made of a-Si doped with an impurity.

Next, as shown in FIGS. 16 to 18, a metal layer is deposited on the ohmic contact stripes 161 and the gate insulating layer 140 and then etched to form data lines 171 having source electrodes 173 and end portions 179, and drain electrodes 175. The data line 171 and the drain electrode 175 may be patterned, like the gate line 121, by using the shaping mold after coating a metal powder in the form of slurry, when a shaping mold with a different thickness may be used in consideration of the stepped differences of the under layer.

Next, exposed portions of the ohmic contact patterns 164 which are not covered with the source electrodes 173 and the drain electrodes 175 are removed to complete a plurality of ohmic contact stripes 161 having a plurality of projections 163 and a plurality of ohmic contact islands 165. The projections 154 of semiconductor stripes 151 are exposed. Oxygen (O2) plasma treatment may follow thereafter in order to stabilize the exposed surfaces of the projections 154 of semiconductor stripes 151.

What is claimed is:

1. Wiring for a display device formed by sintering conductor particles having sizes are smaller than 200 nm.

2. Wiring for a display device of claim 1, wherein the conductor particles comprise at least one selected from among aluminum (Al), copper (Cu), molybdenum (Mo), silver (Ag), chromium (Cr), nickel (Ni), titanium (Ti), tantalum (Ta), cobalt (Co) and alloys thereof.

3. A forming method of wiring for a display device, comprising:
forming a slurry layer which comprises a mixture of conductor particles and a solvent on an insulating substrate;
patterning the slurry layer by using a shaping mold having a prescribed pattern; and
removing the shaping mold.

4. The method of claim 3, wherein the patterning the slurry layer comprises covering the slurry layer with the shaping mold having the prescribed pattern, and pressurizing and heating the slurry layer.

5. The method of claim 4, wherein the pressurization and heating the slurry layer are performed at a temperature of 150 to 500° C.

6. The method of claim 3, wherein the thickness of the slurry layer ranges from 0.5 to 2 μm.

7. The method of claim 3, wherein a step of removing the solvent is further included after the formation of the slurry layer.

8. The method of claim 7, wherein the removing of the solvent comprises a heat treatment which is performed at a temperature of 100 to 200° C.

9. The method of claim 3, wherein a step of etching is further comprised after the removal of the shaping mold.

10. The method of claim 3, wherein the sizes of the conductor particles are lower than 200 nm.

11. A thin film transistor array panel comprising:
a substrate;
a gate line and a data line formed on the substrate, the data line and the gate line intersecting each other;
a thin film transistor connected to the gate line and the data line; and
a pixel electrode connected to the thin film transistor,
wherein at least one of the gate line and the data line is formed by sintering conductor particles whose sizes are lower than 200 nm.

12. The thin film transistor array panel of claim 11, wherein the conductor particles are made of at least one selected from among Al, Cu, Mo, Ag, Cr, Ni, Ti, Ta, Co, and alloys thereof.

13. The thin film transistor array panel of claim 11, wherein the pixel electrode is formed by sintering ITO or IZO.

14. A manufacturing method of a thin film transistor array panel, comprising:
forming a gate line on a substrate;
forming a gate insulating layer on the substrate and a semiconductor layer on the gate insulating layer;
forming a data line having a source electrode and a drain electrode disposed opposite the source electrode with respect to the gate electrode therebetween on the gate insulating layer and the semiconductor layer; and
forming a pixel electrode connected to the drain electrode,
wherein at least one of the formation of the gate line and the formation of the data line comprises a step of forming a slurry layer which is a mixture of conductor particles and a solvent, patterning the slurry layer by using a shaping mold with a prescribed pattern, and removing the shaping mold.

15. The method of claim 14, wherein the patterning comprises covering the slurry layer with the shaping mold having the prescribed pattern, and pressurizing and heating the slurry layer.

16. The method of claim 15, wherein the pressurization and heating are performed at a temperature of 150 to 500° C.

17. The method of claim 14, wherein the thickness of the slurry layer ranges from 0.5 to 2 μm.

18. The method of claim 17, wherein a step of removing the solvent is further comprised after the formation of the slurry layer.

19. The method of claim 18, wherein the removing of the solvent comprises a heat treatment which is performed at a temperature of 100 to 200° C.

20. The method of claim 14, wherein a step of etching is further comprised after the removal of the shaping mold.

21. The method of claim 14, wherein the sizes of the conductor particles are lower than 200 nm.

22. The method of claim 14, wherein the formation of the pixel electrode comprises a step of forming a slurry layer which comprises a mixture of ITO or IZO particles and a solvent, patterning the slurry layer by using a shaping mold with a prescribed pattern, and removing the shaping mold.
Next, as shown in FIGS. 19 to 21, an organic material having substantial passivation properties and photosensitivity, an inorganic material such as SiNx, or a low dielectric insulating material is deposited to form a passivation layer 180 by plasma enhanced chemical vapor deposition (PECVD). Then, photoresist is coated on the passivation layer 180 and exposed to a light through a photo-mask, and the exposed photoresist is then developed to form a plurality of contact holes 181, 182, 184, and 185. Finally, as shown in FIGS. 1 to 3, pixel electrodes 191, contact assistants 81 and 82, and overpasses 84 which are made of a transparent conductor such as ITO are formed on the passivation layer 180.
The transparent conductive layer may be patterned, like the gate line 121, by using the shaping mold after coating a conductor powder such as ITO or IZO in the form of slurry. As in the above descriptions, by forming the electrodes by using slurry which is a mixture of a solvent and a nano-sized metal, the uniformity of the electrodes is enhanced and the manufacturing costs and time are remarkably reduced compared to the photo-etching process using masks.
Although preferred embodiments of the present invention have been described in detail hereinabove, it should be clearly understood that many variations and/or modifications of the basic inventive concepts herein taught, which may appear to those skilled in the present art, will still fall within the spirit and scope of the present invention, as defined in the appended claims.
